(19) United States
(12) Patent Application Publication
(10) Pub. No.: US 2015/0001941 A1
(43) Pub. Date: Jan. 1, 2015

(54) Systems and Methods for Power Management

(71) Applicant: Lexmark International, Inc., Lexington, KY (US)

(72) Inventors: Don Dexter Antonio Antonio, Cebu (PH); Marvin Aliviado Rodrigues, Cebu (PH); Shaun Timothy Love, Lexington, KY (US)

(21) Appl. No.: 13/930,241

(22) Filed: Jun. 28, 2013

(51) Int. Cl. H02J 4/00

(52) U.S. Cl. CPC H02J 4/00
USPC 307/64

(57) ABSTRACT

Methods employ a power saving mode which disconnects power from the AC mains during periods of device inactivity to eliminate power drawn from the AC mains. To allow monitoring of user-associated events while disconnected from the AC mains, power is drawn from a power source separate from the AC mains to power up components and circuitries used for monitoring. When monitoring inputs are received, connection with the AC mains is re-established to provide AC power to the device to accommodate functions.

### FIELD OF THE INVENTION

The present invention relates to managing power consumption of devices, such as imaging devices. More particularly, it relates to a power saving mode which disconnects a device's power supply unit from the AC mains to reduce power draw to zero and utilizes other sources of power for user event monitoring when the device is not in use.

### BACKGROUND

In most geographical locations, strict energy requirements are set as energy conservation has become increasingly important for sustainability. In effect, manufacturers of different devices are continuingly challenged to reduce power drawn from an electrical power grid, i.e., the AC (alternating current) mains, in order to meet power conservation requirements.

Many conventional devices are known to operate in reduced power modes when idle. For example, conventional devices are typically integrated with hardware and/or software functions that allow automatic transitioning from an active or normal operating mode in which devices are fully functional and consume rated power, to one of a plurality of power saving modes in which devices consume reduced power relative to the active mode, during periods of inactivity or reduced device activity.

Power saving modes can be achieved by selectively controlling supply of power to various circuitries within a device to reduce power consumption. Depending on time periods in which the device is idle, the device (or portions thereof) may be placed in one power saving mode. Example power saving modes may include standby mode, sleep mode, and hibernate mode. These power saving modes may save power at different levels by disabling different sets of peripherals or circuitries, with standby mode consuming the most power and then decreasing in power consumption through sleep mode and hibernate mode, for example. Durations for which the device may be placed in a power saving mode can vary from several seconds, minutes, hours, or days, and/or based on user preference.

When in a power saving mode, some device components still remain active and powered to monitor changes or events that may be indicative of a user attempting to access the device, so that the device can automatically exit the power saving mode and return to its active mode in response to receiving inputs from monitoring circuitries. Typically, devices remain to be connected to the AC mains in order to draw small amounts of power therefrom to power up the circuitries used for monitoring. In this way, power drawn from the AC mains is reduced during periods of inactivity of the device, which can save overall power consumption.

While these example approaches have been met with success in terms of reducing power consumption, even lower power consumption is nevertheless desired. Further needs contemplate a power saving mode which reduces power drawn from the AC mains to zero during periods of inactivity of a device. Additional benefits and alternatives are also sought when devising solutions.

### SUMMARY

The above-mentioned and other problems become solved by providing a power saving mode that avoids having to consume power from the AC mains to power up circuitries used for monitoring user-associated events during device inactivity.

In an example embodiment, a method of controlling power used by an electronic device having a power supply subsystem that draws power from an AC power source for operation, and from a second power source separate from the AC power source during idle operation, is provided. The method includes providing a power supply subsystem for receiving power from the AC power source, and a switch between the power supply subsystem and the AC power source. A controller determines whether a predetermined time period has elapsed that the electronic device is in an idle condition, and controls the switch to disconnect the power supply subsystem from the AC power source in response to determining that the predetermined time period has elapsed. Power drawn from the second power source is provided to one or more monitoring circuitries within the electronic device for monitoring user events while the power supply subsystem is disconnected from the AC power source. In this way, substantially no power is drawn by the electronic device from the AC power source while the electronic device is in the idle condition. In an example aspect, the method includes providing a network interface layer block that connects to a network via a network cable supplied with inline power by an inline power source, the inline power source comprising the second power source. In another example aspect, a battery or a capacitor associated with the electronic device is provided as the second power source.

In another example embodiment, a method for controlling power saving of an electronic device is provided. The electronic device includes a power supply for receiving power from an AC (alternating current) power source during an active mode, and a network interface block coupled to an Ethernet cable for drawing inline power therefrom. The method includes providing a switch between the power supply and the AC power source, and detecting ambient light using a light sensor. A controller controls the switch to electrically disconnect the power supply from the AC power source to engage in a power saving mode in which no power is drawn from the AC power source, in response to the light sensor detecting ambient light intensity that is below a predetermined threshold. In an example aspect, detection of ambient light and control of the switch are performed by utilizing the inline power drawn from the network cable such that no power is drawn from the AC power source for the power saving control operations.

These and other embodiments are set forth in the description below. Their advantages and features will become readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 illustrates an example embodiment of a network connection implementing an inline power source and coupling multiple devices;

FIG. 2 is a block diagram in accordance with the present disclosure of an imaging device connected to the AC mains and the network connection;

FIG. 3 is a flowchart in accordance with the present disclosure illustrating an example method for engaging and disengaging the imaging device in FIG. 2 into and out of a cut-off power mode;

FIG. 4 is a block diagram of an electronic module connected between an imaging device and a network line outlet and a wall outlet, in accordance with example embodiments of the present disclosure;

FIG. 5 is a flowchart illustrating an example method for engaging and disengaging the imaging device in FIG. 4 into and out of a cut-off power mode using the electronic module; and

FIG. 6 is a block diagram of the electronic module having a network interface layer block for providing Wake-on-LAN (WOL) functionality, according to an example embodiment of the present disclosure.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that process, electrical, and mechanical changes, etc., may be made without departing from the scope of the invention. The following detailed description, therefore, is not to be taken in a limiting sense and the scope of the invention is defined only by the appended claims and their equivalents. In accordance with the features of the invention, a power saving mode for a device disconnects power from an AC power source during periods of inactivity of the device to eliminate power drawn from the AC power source. To allow monitoring of user-associated events while disconnected from the AC power source, inline power is drawn from a network cable to power up components and circuitries used for monitoring. When monitoring inputs from the monitoring circuitries are received, connection with the AC power source is re-established to provide AC power to the device to accommodate functions.

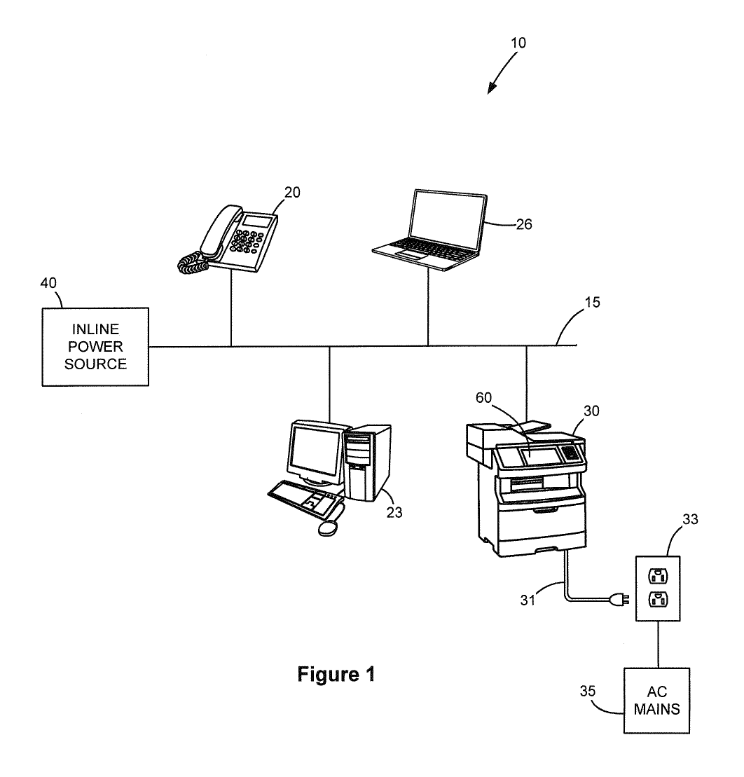

With reference to FIG. 1, an example networked system 10 built around an Ethernet-based network connection 15 is shown having a plurality of devices connected to network connection 15. Any device with network connectivity features may be connected to network connection 15. In the example shown, an IP phone 20, a computer 23, a laptop 26, and an imaging device 30 are connected to network connection 15 via network interface cards (NICs) and network cables. Some connected devices may connect to an AC power source for power to accommodate certain functions. In this example, imaging device 30 includes a cable 31 ending in a plug that plugs into an AC line or wall outlet 33 connected to the AC mains 35.

In an example embodiment, networked system 10 employs Power over Ethernet (PoE) technology by including an inline power source 40, also known as a Power Sourcing Equipment (PSE), located at one end of network connection 15, or alternatively, at other locations between the ends of network connection 15. Generally, inline power source 40 provides power over network connection 15 for use by any networked device designed to use inline power in lieu of or in addition to wall power. Inline power source 40 can be a network switch, a gateway, a network router, a network bridge, a repeater, a patch panel, or any other network node or device capable of providing inline power over network connection 15. In order to source power over network connection 15, inline power source 40 may draw AC power from the AC mains 35 and supply DC (direct current) inline power using unused pairs of a network cable, or alternatively, on the same conductors used to transmit data in such a way that electrical current and data signals neither interferes with the other. In one example, inline power source 40 delivers about 48 V of DC power to PoE-ready networked devices. Of course, other voltage values may be supplied depending on the design requirements. PoE may be implemented as defined in the IEEE 802.3af standard. It will be appreciated, though, that any known technique or standard for transmitting power over Ethernet infrastructures may be utilized.

Typical electronic devices which draw power from the AC mains 35 to function can operate in at least two operating modes, i.e., a normal/active operating mode and a power saving mode. A device operates in an active mode of operation during periods of normal activity in which the device is fully functional and consumes rated power. On the other hand, a device can be configured to operate in a power saving mode in which low power is consumed, relative to the active mode, during periods of inactivity or reduced inactivity. A number of power saving modes exist and are normally initiated based on timeout periods/values set by manufacturers or as specified by user configuration, or upon user request. As will be appreciated, a power saving mode refers to any low-power mode which the device may enter to conserve energy and power. When in a power saving mode, various circuit domains within an electronic device are selectively turned off, or at least provided with reduced power, so as to reduce overall power consumption of the electronic device. Typically, only those circuit domains and/or components used to monitor user events are supplied with sufficient power to keep the electronic device active in monitoring user events.

Examples of power saving modes include, but are not limited to, standby mode, sleep mode, and hibernate mode, and devices can operate in multiple levels of these power saving modes. In each of these example power saving modes, the device continues to be connected to the AC mains 35 to draw relatively small amounts of power therefrom to accommodate monitoring of user events, as previously discussed.

According to example embodiments of the present disclosure, a “cut-off” power saving mode that avoids having to consume power from the AC mains 35 during periods of device inactivity may be utilized to effectively reduce power drawn from the AC mains to zero. In the cut-off mode, the device is disconnected from the AC mains 35 by controlling to open a switch connected between the device's power supply unit and the AC mains. Cut-off mode can be activated in a variety of ways, such as based on predetermined timeout periods, user request, sensor outputs indicating absence of a user in proximity, and others. The device, though deprived of AC power from the AC mains, may still remain partially “ON” to monitor changes associated with user events by drawing power from other alternative power sources. In an example embodiment, the device utilizes inline power provided over network cables by an inline power source to power up device components used for monitoring. In this way, drawing of power from the AC mains for monitoring when the device is idle can be rendered unnecessary, and improved overall power savings can be achieved.

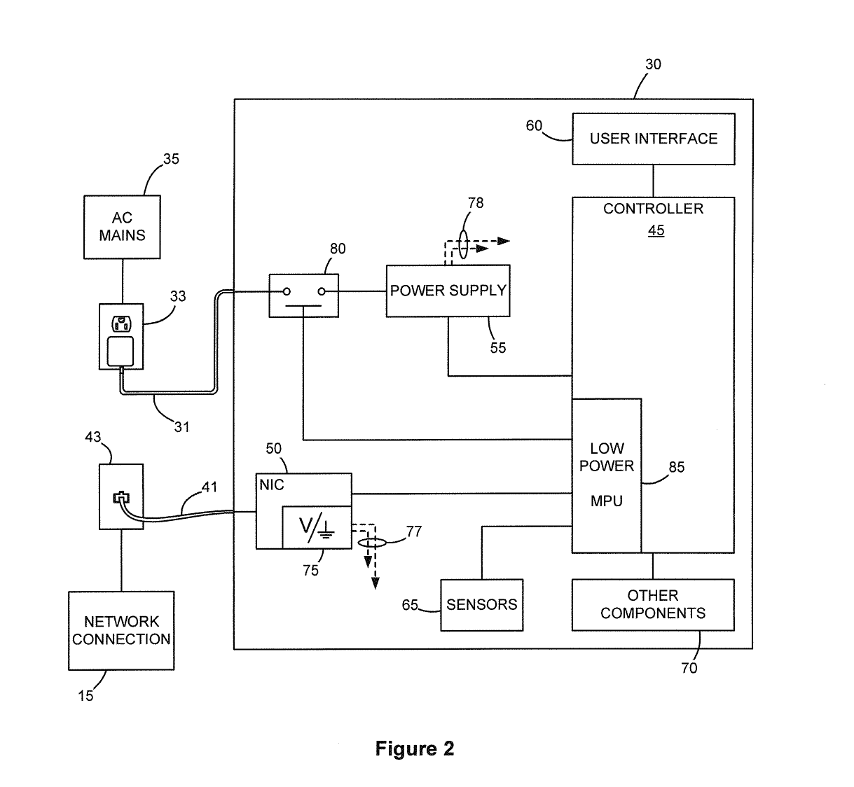

FIG. 2 illustrates a representative embodiment of imaging device 30 capable of engaging in the cut-off power saving mode described above. Of course, it is understood that use of imaging device 30 is only for purposes of illustration and that any other device, such as those other devices shown in FIG. 1, can be made operable to engage in the cut-off power saving mode. Generally, imaging device 30 physically connects to the AC mains 35 via power cable 31 for power to support various functions during normal activity, and to network connection 15 via a network cable 41 and a network line outlet 43 for communicating data over the network.

Imaging device 30 includes a controller 45, which may be in the form of an application specific integrated circuit (ASIC). Controller 45 typically contains digital logic and communicates with various other components resident on imaging device 30. These may include a network interface card (NIC) 50, a power supply unit 55, a user interface 60, sensors 65, volatile and/or non-volatile memory modules (not shown), and several other components 70.

User interface 60 may include a graphical user interface for receiving user input concerning operations performed or to be performed by imaging device 30, and for providing to the user information concerning same. In one example, user interface 60 includes a display panel (FIG. 1), which may be a touch screen display in which user input may be provided by the user touching or otherwise making contact with graphic user icons in the display panel. User interface 60 may also include input keys for receiving different user inputs.

NIC 50 provides a physical connection between network connection 15 and imaging device 30. It is generally a physical layer and a data link layer device, and can either be integrated into a motherboard chipset or implemented via a dedicated Ethernet chip connected through an interface bus. In an example embodiment NIC 50 is capable of supporting PoE. Thus, it is operable to transmit/receive data over network connection 15, and receive inline power over a network cable, if inline power is available. NIC 50 can receive inline power from inline power source 40 in a variety of ways. In one example, inline power source 40 may supply appropriate DC voltages required by NIC 50. In another example, typical voltage in Ethernet applications, such as 48 volts, may be supplied over the network cables and a DC to DC converter may be implemented as part of NIC 50, or alternatively located elsewhere in imaging device 30, to transform voltages received by NIC 50 to provide 3.3 volts, or other voltages as may be required by other resident components of imaging device 30. Inline power can be delivered to various components by a voltage/ground source 75 via a power bus 77, for example.

Power supply 55 typically contains analog circuitry necessary to convert AC voltage from the AC mains 35 to one or more regulated DC voltages for use by components of imaging device 30. Power supply 55 may deliver appropriate regulated DC voltage levels to various components and circuitries via a power bus 78. Power supply 55 connects to the AC mains 35 via a switch 80. Switch 80 can comprise a mechanical switch, an electronic switch, a relay switch, a semiconductor device, or any kind of switch. Switch 80 is communicatively coupled to controller 45 and is configured to receive control signals therefrom containing instructions to selectively connect and disconnect power supply 55 to and from the AC mains 35 based on device usage. In general, switch 80 is initially closed during device startup and remains closed for durations in which imaging device 30 is in use, and opens during periods of device inactivity, or upon deliberate request from a user, to effectively cut off power from the AC mains 35. To manage these functions, imaging device 30 may employ a power management system implemented using controller 45.

In an example embodiment, imaging device 30 includes a low-power microprocessor unit (MPU) 85 designed for use during one or more power saving modes, such as the cut-off power mode previously described. In this example, MPU 85 is provided as part of controller 45 and operates on low voltages, such as from 2 to 5 Volts. Alternatively, MPU 85 may be provided separately from, but associated with, controller 45. MPU 85 generally functions to control the state of switch 80. In order to function while in cut-off mode, MPU 85 draws inline power via voltage/ground source 75 to remain active while other portions of controller 45 are powered off. During use, MPU 85 runs firmware to monitor trigger signals indicative of instructions to wake imaging device 30 from the cut-off mode by controlling switch 80 to close. Closing switch 80 effectively reconnects power supply 55 to the AC mains 35 and causes imaging device 30 to power back on and exit the cut-off mode.

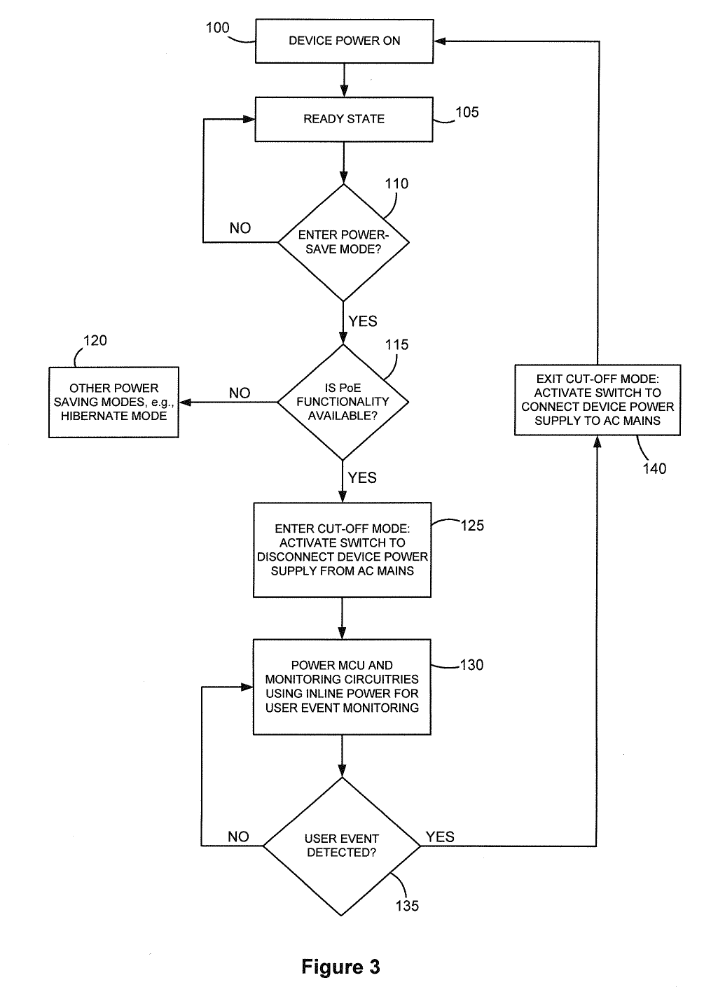

Using its power management system, imaging device 30 may enter and exit into and out of the cut-off mode. FIG. 3 is a flowchart illustrating an example process.

At 100, imaging device 30 is powered on after connection with the AC mains 35 is established. Once power is supplied, imaging device 30 undergoes a power-on reset (POR), performs initializations, and eventually enters “ready state” at 105. Part of the initialization process may include determining existence of PoE support as well as an availability of inline power over the network cable. A positive determination may provide additional configuration options for setting up imaging device 30. For example, options for configuring imaging device 30 to enter cut-off mode can be provided via user interface 60 if PoE is supported.

While in the ready state, a user may configure imaging device 30 with any necessary configurations for setting up, defining, or selecting certain properties, attributes, parameters, or options associated with one or more power saving modes. More particularly, imaging device 30 can engage in multiple levels of power saving modes and the user may set the time durations for which imaging device 30 may be placed in each of the power saving modes. These timing durations may vary from indefinite to several seconds, minutes, hours, or days. Further, in this example, hibernate mode and cut-off mode operate with the least amount of power required among the power saving modes, with hibernate mode drawing power from the AC mains 35 and cut-off mode drawing power from inline power source 40.

At 110, a determination is made if set conditions for engaging in at least one power-saving mode are met. Upon a negative determination, imaging device 30 continues to remain in its ready state. If set conditions are satisfied, process proceeds to 115 where it is further determined if PoE functionality is available. In this example, PoE functionality is determined to be available if NIC 50 is equipped with PoE capability and inline power is provided over the network cable, as determined in the initialization steps. If PoE functionality is not available, imaging device 30 may enter a different power saving mode other than the cut-off mode, such as hibernate mode, at 120. Otherwise, imaging device 30 enters cut-off mode at 125 where controller 45 activates switch 80 to disconnect power supply 55 from the AC mains 35.

While in the cut-off mode, MPU 85 is powered using inline power drawn from the network cable at 130. Additionally, circuitries/components for monitoring user events and interventions are also powered using inline power, and signals from which are used by MPU 85 to determine when to wake imaging device 30 from the cut-off mode. MPU 85 can transfer power to monitoring circuitries through wires electrically coupling them to MPU 85. In another example, monitoring circuitries can receive power directly from voltage/ground source 75. In still other examples, use of additional circuitries on board to receive voltages from voltage/ground source 75 and convert received voltages into forms suitable for use by different monitoring circuitries is contemplated.

User-associated events that trigger MPU 85 to control exit from the cut-off mode may be provided in different forms. In one example embodiment, MPU 85 may be responsive to trigger signals actuated by print jobs sent from external devices to imaging device 30 over network connection 15. In this example, NIC 50 must support Wake-on-LAN (WOL) functionality. In general, WOL is an Ethernet-based networking standard that allows network connected devices to be turned on or woken up through network packets. WOL support can be implemented on the network interface, such as NIC 50, and on MPU 85, and may require software and hardware drivers to function. WOL is implemented by transmitting a wake up packet, also known as “magic packet,” from a program executed on a remote device to a destination network-connected device. The magic packet is uniquely defined to wake up the destination device and contains the MAC (Media Access Control) address thereof. The magic packet is transmitted as a broadcast packet which can be received and identified by each network-connected device to recognize whether or not a magic packet is addressed to it. Upon receiving a magic packet and recognizing the MAC address contained therein, a destination device can initiate system wake-up. Otherwise, a receiving device may remain in its power saving state.

In order for WOL functionality to work, at least portions of NIC 50 circuitry responsible for detecting magic packets are required to remain active or turned on while imaging device 30 is in the cut-off power saving mode. In an example embodiment, NIC 50 consumes inline power to operate in the cut-off mode. It is further operative to detect magic packets transmitted over network connection 15, recognize the magic packets, and determine whether WOL instructions contained in the magic packets were intended for imaging device 30 which it supports.

As an example, a user may create a print job request using computer 23 in FIG. 1. Prior to sending the print job request, computer 23, equipped with associated printer software/hardware drivers which support WOL, may generate and transmit a magic packet intended to wake up imaging device 30 over network connection 15. MC 50 within imaging device 30 may receive and detect the magic packet and perform an address comparison to determine if its MAC address matches the MAC address contained in the magic packet. If a match exists, imaging device 30 may proceed to wake up from the cut-off mode. More particularly, NIC 50 transmits a signal to MPU 85 indicative of the WOL request, and MPU 85 may respond accordingly by controlling switch 80 to close to reconnect power supply 55 to the AC mains 35. Subsequently after sending the magic packet, computer 23 may transmit the print job request to imaging device 30. The timing in which print job requests are sent after magic packets can be implemented in different ways. In one example, computer 23 may try to communicate a print job request several times after sending one or more magic packets until an acknowledgment is received from imaging device 30. In another example, computer 23 may wait a predetermined period of time after transmitting a magic packet before subsequently sending a print job request. In other examples, computer 23 may wait for an indication from imaging device 30 that it is ready to receive print job requests. Of course, other methods may be utilized depending on the design contemplated.

In another example embodiment, MPU 85 can be programmed to wake imaging device 30 from the cut-off mode upon receiving trigger signals indicative of user-initiated actions on imaging device 30. For example, user-initiated actions may include a user touching the display panel, pressing a power button/indicator, opening covers or media trays, and other actions indicative of a user attempting to physically access imaging device 30. Monitoring sensors 65 used to detect user-initiated actions during cut-off mode remains active by consuming power drawn (received) from inline power source 40 via NIC 50.

In another example embodiment, signals for triggering imaging device 30 to wake up from the cut-off mode may be generated based on set timeout configurations. Users may set a length of time imaging device 30 can stay in the cut-off mode using user interface 60. For example, users may choose to set imaging device 30 to stay in cut-off mode for particular non-working hours, such as from 7 p.m. to 7 a.m. on working days, and/or for non-working days, such as on weekends or holidays. Using a timer clock, MPU 85 can put imaging device 30 into the cut-off mode, and conversely, out of the cut-off mode based on the specified times by selectively controlling switch 80 to open and close.

In another example embodiment, imaging device 30 can be triggered to wake up from the cut-off mode based on detected light conditions. In one example aspect, a light sensor can be used to detect if ambient/room lights are turned on by detecting relatively large changes in light level or when detected light intensity is above a predetermined threshold, and provide a trigger signal to MPU 85 in response to a positive determination. Such trigger signal may indicate MPU 85 to control switch 80 to close in order for imaging device 30 to exit the cut-off mode. In this example aspect, the light sensor also utilizes inline power for operation. To provide economical light sensors, LEDs (light emitting diodes) comprising the display panel of user interface 60 may be used as a photodiode for light detection as well as emission. Switching between emitting and sensing can be done at a rate that would not introduce any noticeable flicker. It will be appreciated, though, that other types of light sensors can be used.

In another example aspect, amounts of changes in detected light conditions may be used to determine whether to wake up imaging device 30 from the cut-off mode. For example, when sensing light using LEDs of the display panel, relatively small changes in detected light conditions (or detected light intensity is within a predetermined range) which may be indicative of a user approaching imaging device 30 or casting a shadow on the display panel in an attempt to access it, can be used to trigger MPU 85 to control imaging device 30 to exit the cut-off mode. Conversely, the same light sensor can be used to trigger imaging device to enter the cut-off mode when relatively large changes in light conditions are detected (or detected light intensity is below a predetermined threshold), such as when room lights are turned off.

Referring back to the flowchart in FIG. 3, imaging device 30 remains in the user event monitoring condition at 135 while it is in cut-off mode. Once a user event is detected, an electrical signal indicative of the user event is sent by the monitoring component which detected it to MPU 85. In response, MPU 85 controls switch 80 to close at 140 so that imaging device 30 may power on at 100, enter POR state, perform necessary initializations and/or warm-up operations, and eventually return to ready state at 105 where it can perform user requested functions.

The above example embodiments have been described with NIC 50 having PoE functionalities which allow imaging device 30 to draw inline power from an inline power source while disconnected from the AC mains 35. There are other devices, however, that may have network infrastructures that do not support PoE (or may not have network infrastructures at all), and thus may not be able to benefit from inline power to support cut-off mode features. In order to address this issue, an electronic module capable of controlling a device to enter and exit cut-off mode using inline power drawn from an inline power source, may be provided.

In general, the electronic module is an external intermediary device that can connect to the NIC and power supply unit of an end device, provide connectivity between the end device's NIC to the network, and can selectively connect/disconnect the end device's power supply unit to/from the AC mains. Accordingly, the electronic module more reliably serves as a proxy for a network line outlet and a wall outlet. It includes a controllable switch for selectively connecting and disconnecting the end device to and from the AC mains based on monitoring inputs. In addition, it may be equipped with PoE functionality to enable inline power consumption for operation while cut off from the AC mains. This would allow control and monitoring circuitries to function without drawing power from the AC mains, and thus may provide cut-off mode functionalities to end devices without PoE support.

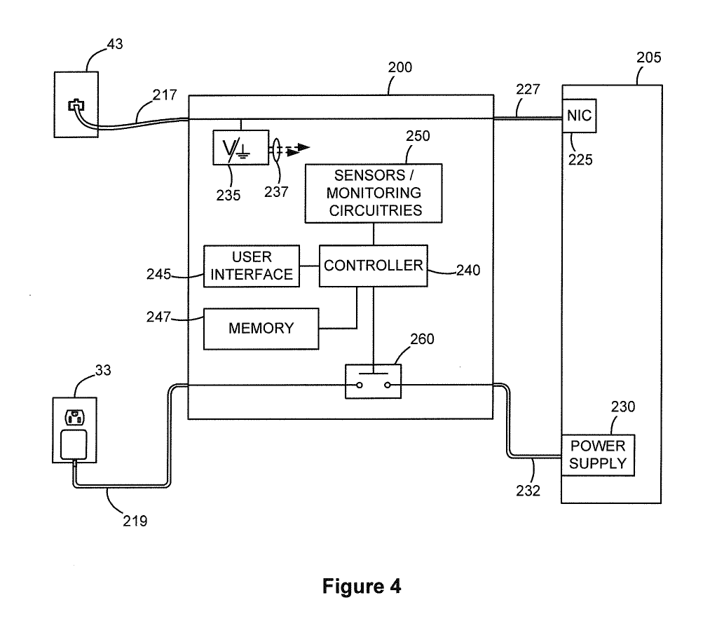

FIG. 4 shows an example electronic module 200 connected between an imaging device 205 with no PoE support, and wall outlet 33 and network line outlet 43. At one end, electronic module is physically connected to network line outlet 43 via a network cable 217, and to wall outlet 43 via a power cable 219. At the other end, it physically connects to imaging device 205, more particularly to an associated NIC 225 via a network cable 227, and to a power supply unit 230 via a power cable 232. Electronic module 200 links the two network cables 217 and 227 to allow passage of incoming and outgoing data packets communicated over the network. Further, it is operable to receive inline power from network cable 217 and deliver drawn inline power to various circuitries within electronic module 200 using a voltage/ground source 235 via a power bus 237, for example. These various circuitries may include a controller 240, a user interface 245, a memory 247, and sensor/monitoring circuitries 250. Meanwhile, power cables 219 and 232 are either connected to or disconnected from each other using a switch 260 depending on control signals received thereby from controller 240. Transmission of the control signals from controller 240 to switch 260 may be triggered by monitoring inputs indicative of user-associated actions or events sent by the sensor/monitoring circuitries 250 to controller 240.

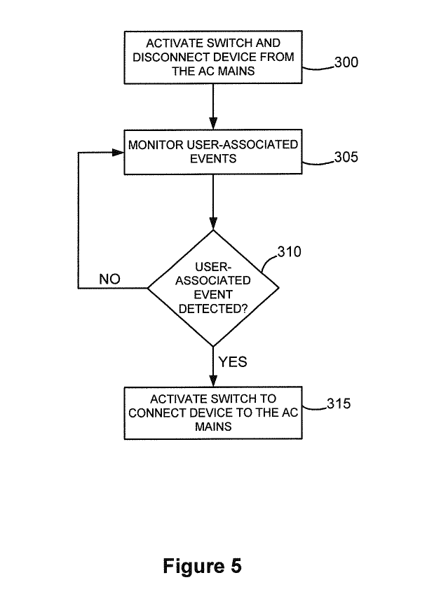

FIG. 5 is a flowchart illustrating an example process of controlling imaging device 205 to enter and exit the cut-off power saving mode using electronic module 200.

At 300, controller 240 may activate switch 260 to disconnect imaging device 205 from the wall outlet 210 to eliminate power drawn from the AC mains based on monitoring inputs. Several types of monitoring inputs can be used to trigger controller 240 to disconnect switch 260. In one example, using user interface 245, users may be allowed to set a particular time on when imaging device 205 is desired to enter the cut-off mode in order to save power, and monitoring inputs for triggering controller 240 may be generated based on the set time configurations/settings. The time settings can be stored in memory 247 and used by controller 240 to determine when to disconnect switch 260. For example, if electronic module 200 is set to disconnect switch 260 at 7 p.m. on a particular day, trigger signals from a timer clock, for example, may be provided to controller 240 at such particular time and day, indicative of instructions to disconnect switch 260.

In another example, monitoring inputs can come from a light sensor incorporated to detect changes in light conditions. For example, the light sensor can be used to detect relatively large changes in light conditions which may be indicative of room lights being turned off, and controller 240 may be configured to disconnect switch 260 if these changes are detected. In other example embodiments, other forms of sensing mechanisms can be used to provide monitoring inputs for automatically triggering cut-off mode. Alternatively, keys for receiving manual inputs from users may be used for triggering activation of the cut-off mode.

At 305, electronic module 200 monitors changes indicative of user associated events and remains in the monitoring condition at 310 while switch 260 is disconnected. Events that trigger controller 240 to control exit from the cut-off mode may come in different forms. In one example embodiment, users may be allowed to further set a particular time on when imaging device 205 is desired to exit the cut-off mode using user interface 245, and monitoring inputs for triggering may be generated based on these time settings. For example, a user may set electronic module 200 to connect switch 260 at 7 a.m. on a particular day, and controller 240 may reconnect switch 260 on such specified time to automatically power back on imaging device 30. Alternatively, a timer can be preprogrammed to control electronic module 200 to exit the cut-off mode after a predetermined amount of time. In another example embodiment, a bypass power button may be provided on user interface 60 to allow users to manually control electronic module 200 to re-establish connection with the AC mains in order to exit cut-off mode at anytime if so desired.

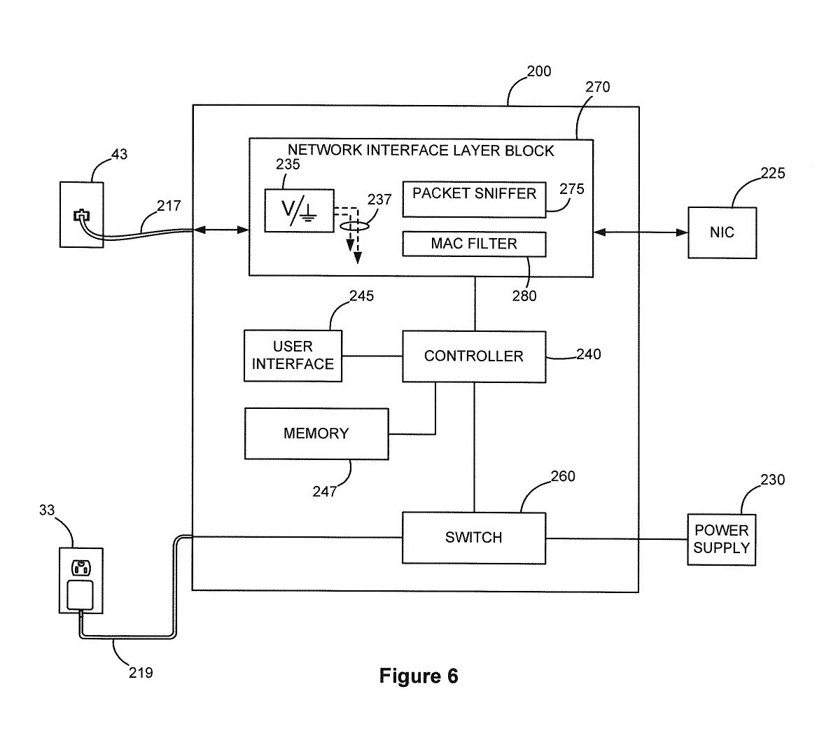

In another example embodiment, controller 240 may be responsive to trigger signals actuated by magic packets associated with print jobs sent from external devices to imaging device 205 over network connection 15. In this example, electronic module 200 must support WOL functionality. FIG. 6 illustrates at least portions of some example internal components within electronic module 200 that may provide WOL support, according to an example embodiment.

As shown, electronic module 200 incorporates a network interface layer block 270 for detecting magic packets transmitted over the network connection 15. Network interface layer block 270 interfaces with controller 240 and provides necessary information needed by controller 240 to determine when to activate switch 260 for reconnecting with the AC mains. As previously described, a magic packet typically contains the MAC address of a destination device to be woken up. Accordingly, in order to determine if a magic packet is intended for imaging device 205, electronic module 200 may store the MAC address of NIC 225 in its memory 247 for use in such determination.

In one example aspect, electronic module 200 may automatically copy/clone the MAC address of NIC 225. In this example, network interface layer block 270 includes a packet sniffer 275 for observing network traffic transmitted over network cables 217 and 227, and a MAC filter 280 to perform MAC address extraction. Typically, since devices that communicate on an Ethernet network have to use Ethernet packets, and since an Ethernet packet must have a physical address for it to be delivered on the data link network, electronic module 200 may be used to observe outbound Ethernet packets from NIC 225, using for example packet sniffer 275, and capture the MAC address of NIC 225 contained in the outbound Ethernet packets, using for example MAC filter 280. This may occur at startup of imaging device 205, such as when its NIC 225 attempts to communicate with a network node to request for an IP address. Of course, capturing of MAC addresses at other instances is also contemplated. MAC filter 280 may provide the captured MAC address to controller 240 for storage in memory 247. In other example aspects, users may manually input and store the MAC address of NIC 225 on electronic module 200 via user interface 245, for example. The MAC address identifying imaging device 205 may remain in memory 247 unless otherwise reset or replaced, as per user request.

Once the MAC address of NIC 225 has been captured and stored, packet sniffer 275 may be used to passively sniff incoming Ethernet packets for magic packets while switch 260 is disconnected. If a magic packet is received, MAC filter 280 may extract the MAC address contained in the magic packet and provide the extracted MAC address to controller 240. In turn, controller 240 may determine if WOL instructions contained in the magic packet were intended for imaging device 205 by comparing the extracted MAC address and the MAC address stored in memory 247. If the two MAC addresses match, controller 240 may recognize the magic packet as being indicative of an incoming print job request from a user. Trigger signals for controller 240 are thus generated based upon received magic packets destined for imaging device 205.

Referring back to the flowchart in FIG. 5, electronic module 200 activates switch 260 to close at 315 if any user-associated event is detected. In particular, it provides a control signal to switch 260 containing instructions to re-establish connection with the AC mains in order to exit the cut-off mode. As connection with the AC mains is re-established by electronic module 200, imaging device 205 may power on, enter POR state, perform necessary initializations and/or warm-up operations, and eventually return to ready state where it can perform user requested functions.

In the above example embodiments, utilization of inline power has been described to provide power to various monitoring circuitries while device is in cut-off mode. In alternative example embodiments, rechargeable battery systems or capacitors associated with a device may be used as alternative sources of power, in lieu of inline power, during cut-off power mode. In still other example embodiments, usage of inline power even during device active mode is contemplated. In this case, monitoring circuitries that are meant to monitor changes during cut-off mode are powered using inline power, if available. In this way, inline power is leveraged to further reduce power consumption from the AC mains even during normal operation and/or while engaging in other power saving modes. Further, although the example flowcharts illustrate certain instances of utilizing cut-off power mode, it is understood that other embodiments also contemplate multiple levels of low power mode, for example, sequentially from standby, sleep, hibernate, and cut-off From a ready state, the power modes can be triggered by a timer clock, with differing amounts of time for each mode to be activated, or using any combination of triggering methods. In addition, although the description of the details of the example embodiments have been described in the context of an imaging device, it will be appreciated that the teachings and concepts provided herein are applicable to other electronic or computing devices, and systems.

Relatively apparent advantages of the many embodiments include, but are not limited to, providing a power saving mode which reduces power draw from the AC mains to zero, and providing a means to continue monitoring of user events while engaged in such power saving mode although disconnected from the AC mains. Advantages also introduce notions of utilizing inline power provided by inline power sources over network cables in power saving modes to provide power to switching and/or monitoring circuitries which may render power draw from the AC mains unnecessary.

The foregoing illustrates various aspects of the invention. It is not intended to be exhaustive. Rather, it is chosen to provide the best illustration of the principles of the invention and its practical application to enable one of ordinary skill in the art to utilize the invention, including its various modifications that naturally follow. All modifications and variations are contemplated within the scope of the invention as determined by the appended claims. Relatively apparent modifications include combining one or more features of various embodiments with features of other embodiments.

1. A method of controlling power used by an electronic device that draws power from an AC (alternating current) power source during normal operation, and from a second power source separate from the AC power source during idle operation, comprising:
providing a power supply subsystem for receiving power from the AC power source;
providing a switch between the power supply subsystem and the AC power source;
determining whether a predetermined time period has elapsed that the electronic device is in an idle condition;
controlling the switch to disconnect the power supply subsystem from the AC power source in response to determining that the predetermined time period has elapsed; and
providing power drawn from the second power source to one or more monitoring circuitries within the electronic device for monitoring user events while the power supply subsystem is disconnected from the AC power source such that substantially no power is drawn by the electronic device from the AC power source while the electronic device is in the idle condition.

2. The method of claim 1, further comprising providing a network interface layer block that connects to a network cable supplied with inline power by an inline power source, the inline power source being the second power source and the network interface layer block receiving said inline power for use by the electronic device while the electronic device is in the idle condition.

3. The method of claim 2, further comprising controlling the switch to reconnect the power supply subsystem to the AC power source upon the network interface layer block receiving a Wake-on-LAN (WOL) signal sent from an external device over the network cable.

4. The method of claim 1, further comprising controlling the switch to reconnect the power supply subsystem to the AC power source upon the one or more monitoring circuitries detecting at least one user event.

5. The method of claim 4, wherein the detecting the at least one user event includes detecting user actions indicative of a user attempting to physically access the electronic device.

6. The method of claim 1, further comprising detecting ambient light, determining whether detected ambient light intensity is below a predetermined threshold, and controlling the switch to disconnect the power supply subsystem from the AC power source if the detected ambient light intensity is below the predetermined threshold.

7. The method of claim 1, further comprising detecting ambient light, determining whether detected ambient light intensity is above a predetermined threshold, and controlling the switch to reconnect the power supply subsystem to the AC power source if the detected ambient light intensity is above the predetermined threshold.

8. A method for transitioning an electronic device between an active mode and a power saving mode, comprising:
providing a switch having a first terminal for connecting to an AC (alternating current) power source, and a second terminal for connecting to a power supply subsystem of an electronic device;
providing a second power source different from the AC power source;
while in the active mode, controlling the switch to connect the first and second terminals to supply AC power to the electronic device;
activating the switch to disconnect the first terminal from the second terminal upon receiving trigger signals indicative of instructions to engage in the power saving mode to substantially eliminate power consumption by the electronic device from the AC power source;
while the first terminal is disconnected from the second terminal, monitoring user-associated events using one or more sensors, the one or more sensors utilizing power from the second power source for operation; and
activating the switch to reconnect the first terminal to the second terminal in response to the one or more sensors detecting an occurrence of at least one user-associated event.

9. The method of claim 8, further comprising providing a network interface having an input for connecting with a network cable supplied with inline power by an inline power source, the inline power source being the second power source and the network interface receiving the inline power for use by the one or more sensors.

10. The method of claim 8, wherein the receiving the trigger signals includes receiving signals from a light sensor detecting ambient light intensity that is below a predetermined threshold.

11. The method of claim 8, wherein the detecting the occurrence of the at least one user-associated event includes detecting a user pressing a bypass power button.

12. The method of claim 8, wherein the detecting the occurrence of the at least one user-associated event includes determining lapse of a predetermined time period set by a user.

13. The method of claim 8, wherein the detecting the occurrence of the at least one user-associated event includes receiving a Wake-on LAN (LAN) packet transmitted from an external device via a network cable.

14. The method of claim 8, further comprising activating the switch to reconnect the first and second terminals in response to a light sensor detecting ambient light intensity that is above a predetermined threshold.

15. A method for controlling power saving of an electronic device that includes a power supply for receiving power from an AC (alternating current) power source during an active mode, and a network interface block coupled to an Ethernet cable for drawing inline power therefrom, comprising:
providing a switch between the power supply and the AC power source;
detecting ambient light using a light sensor; and
controlling the switch to electrically disconnect the power supply from the AC power source to engage in a power saving mode in which no power is drawn from the AC power source, in response to the light sensor detecting ambient light intensity that is below a predetermined threshold;
wherein the detecting and the controlling are performed by utilizing the inline power drawn from the network cable.

16. The method of claim 15, wherein the detecting the ambient light includes detecting using one or more light-emitting diodes of a display panel of the electronic device.

17. The method of claim 15, further comprising controlling the switch to electrically connect the power supply to the AC power source to disengage from the power saving mode in response to the light sensor detecting ambient light intensity that is above a predetermined threshold.

18. The method of claim 15, further comprising controlling the switch to electrically connect the power supply to the AC power source after lapse of a predetermined timeout period.

19. The method of claim 15, further comprising controlling the switch to electrically connect the power supply to the AC power source upon receiving a Wake-on-LAN (WOL) packet destined for the electronic device.

20. The method of claim 15, further comprising controlling the switch to electrically connect the power supply to the AC power source in response to receiving a signal indicative of a user pressing power button.
